(19) United States
(12) Patent Application Publication
(10) Pub. No.: US 2016/0081050 A1
(43) Pub. Date: Mar. 17, 2016

(54) WIRELESS COMMUNICATIONS TERMINAL, WIRELESS COMMUNICATIONS SYSTEM AND WIRELESS COMMUNICATION METHOD

(71) Applicant: SAMSUNG ELECTRO-MECHANICS CO., LTD., Suwon-si (KR)

(72) Inventors: Chang Ju LEE, Suwon-si (KR); Yong Gil NAMGUNG, Suwon-si (KR); Jong Gi RYU, Suwon-si (KR)

(73) Assignee: SAMSUNG ELECTRO-MECHANICS CO., LTD., Suwon-si (KR)

(21) Appl. No.: 14/711,027

(22) Filed: May 13, 2015

(30) Foreign Application Priority Data
Sep. 11, 2014 (KR) 10-2014-0120123

(51) Int. Cl. H04W 60/00; H04L 29/06; H04W 60/04; H04W 48/16

(52) U.S. Cl. CPC H04W 60/00; H04W 48/16; H04L 65/102; H04W 60/04

(57) ABSTRACT

A wireless communications method may includes scanning adjacent channels, transmitting a communications request signal to a gateway via any channel among the scanned channels, receiving a communications response signal including information regarding a plurality of data channels from the gateway via the channel through which the communications request signal is transmitted, transmitting an activation request signal to the gateway via any data channel among the plurality of data channels, receiving an activation response signal from the gateway via the data channel through which the activation request signal is transmitted, and registering the data channel through which the activation response signal is received as the data channel for performing data communications with the gateway.

### CROSS-REFERENCE TO RELATED APPLICATION

This application claims priority to, and the benefit of, Korean Patent Application No. 10-2014-0120123 filed on Sep. 11, 2014, with the Korean Intellectual Property Office, the disclosure of which is incorporated herein by reference.

### BACKGROUND

The present disclosure relates to a wireless communications terminal, a wireless communications system, and a wireless communications method.

In the field of wireless communications, in accordance with demand for the development of technology allowing for low power Zigbee® communications and significantly reducing channel interference in a wireless personal area network (WPAN), research into such technology has been actively conducted.

A channel interference may be a problem, particularly due to the fact that the commonly-used Zigbee® frequency band and the commonly-used wireless local area network (WLAN) and Bluetooth frequency band are both 2.4 GHz.

In general, a wireless communications system includes a server, a cooperative device, and a terminal device, wherein the cooperative device and the terminal device receive and transmit data via a wireless network. Here, in order for the cooperative device and the terminal device to receive data from and transmit data to each other, a data channel should be registered.

In a wireless communications system according to the related art, the cooperative device allocates one data channel to one wake up channel.

In this case, first the terminal device transmits a use request message through the wake up channel. When the terminal device receives a response message from the cooperative device, the terminal device requests registration using the data channel allocated to the wake up channel. When the terminal device receives a registration response message from the cooperative device, the terminal device registers the corresponding data channel. Here, if the registration response message does not arrive within a predetermined time, the terminal device performs four reattempts for the same channel and is then switched to an inactive state.

However, since one data channel is allocated to one wake up channel in such a wireless communications system according to the related art, when interference between the data channel and a channel of another communications system such as a WLAN or Bluetooth-enabled devices occurs, a plurality of use requests for the corresponding data channel are unnecessarily attempted, even though it may be difficult to use the corresponding data channel. As a result, data communications may be delayed for a significant amount of time, leading to battery power being wasted.

### SUMMARY

An exemplary embodiment in the present disclosure may provide a wireless communications terminal capable of reducing a data communications time by registering a data channel for performing data communications with the gateway using a list including information regarding a plurality of data channels, a wireless communications system, and a wireless communications method.

An exemplary embodiment in the present disclosure may also provide a wireless communications terminal, a wireless communications system, and a wireless communications method capable of rapidly responding to a case in which communications problems such as channel interference, and the like occur, by attempting channel registration with another channel when the channel registration with any channel among a plurality of data channels fails, and significantly reducing battery consumption by decreasing unnecessary registration request attempts.

According to an exemplary embodiment in the present disclosure, a wireless communications method may include: scanning adjacent channels; transmitting a communications request signal to a gateway via any channel among the scanned channels; receiving a communications response signal including information regarding a plurality of data channels from the gateway via the channel through which the communications request signal is transmitted; transmitting an activation request signal to the gateway via any data channel among the plurality of data channels; receiving an activation response signal from the gateway via the data channel through which the activation request signal is transmitted; and registering the data channel through which the activation response signal is received as the data channel for performing data communications with the gateway.

The wireless communications method may further include, after the transmitting of the activation request signal, transmitting the activation request signal to the gateway via another data channel among the plurality of data channels when the activation response signal is not received from the gateway within a predetermined period of time.

The wireless communications method may further include, after the transmitting of the activation request signal to the gateway via another data channel among the plurality of data channels, transmitting the activation request signal to the gateway by changing the data channel when the activation response signal is not received from the gateway within the predetermined period of time.

According to another aspect of the present disclosure, a wireless communications terminal may include: a channel scanning unit scanning adjacent channels; a wireless communications unit performing wireless communications with a gateway; and a channel registering control unit transmitting a communications request signal to the gateway via the wireless communications unit using any channel among the scanned channels, transmitting an activation request signal to the gateway via the wireless communications unit using any one of a plurality of data channels upon receiving a communications response signal including information regarding the plurality of data channels from the gateway, and registering the data channel as a data channel for performing data communications with the gateway upon receiving an activation response signal from the gateway via the data channel.

The channel registering control unit may transmit the activation request signal by changing the data channel when the channel registering control unit does not receive the activation response signal from the gateway within a predetermined period of time.

According to another aspect of the present disclosure, a wireless communications system may include: a gateway estimating data channels having no interference using information regarding an adjacent channel and generating a list including information regarding a plurality of data channels being estimated; and a terminal scanning adjacent channels, transmitting a communications request signal to the gateway using any channel among the channels, receiving a communications response signal including the list from the gateway, transmitting an activation request signal to the gateway using any channel among data channels included in the list, and registering the data channel as a data channel for performing data communications with the gateway when an activation response signal is received from the gateway via the data channel.

### BRIEF DESCRIPTION OF DRAWINGS

The above and other aspects, features and other advantages of the present disclosure will be more clearly understood from the estimating detailed description taken in conjunction with the accompanying drawings, in which:

FIG. 1 is a block diagram illustrating a wireless communications system according to an exemplary embodiment in the present disclosure;

FIG. 2 is a flow chart illustrating a wireless communications method according to an exemplary embodiment in the present disclosure;

FIG. 3 is a flow chart illustrating a wireless communications method according to another exemplary embodiment in the present disclosure;

FIG. 4 is a flow chart illustrating a wireless communications method according to another exemplary embodiment in the present disclosure; and

FIG. 5 is a block diagram of a wireless communications terminal according to an exemplary embodiment in the present disclosure.

### DETAILED DESCRIPTION

Hereinafter, embodiments in the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

Throughout the drawings, the same or like reference numerals will be used to designate the same or like elements.

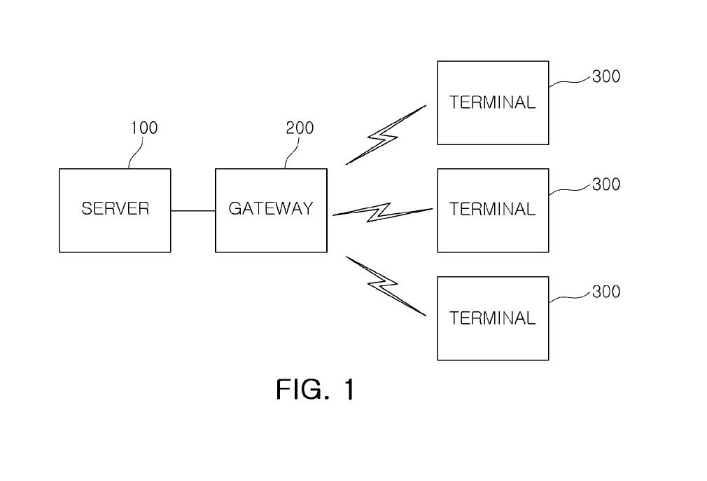

FIG. 1 is a block diagram illustrating a wireless communications system according to an exemplary embodiment in the present disclosure.

Referring to FIG. 1, a wireless communications system according to an exemplary embodiment in the present disclosure may include a gateway 200 that transmits data to and receives data from a server 100, and terminals 300 connected to the gateway 200 via wireless communications.

The gateway 200 may be connected to the server 100 in a wired manner via an Ethernet LAN so as to receive and transmit the data, and may be connected to at least one terminal 300 via wireless communications. According to an exemplary embodiment, the gateway 200 and the terminal 300 may be connected to each other via a wireless network based on the 802.15.4 protocol.

According to an exemplary embodiment in the present disclosure, when the gateway 200 forms a network with at least one terminal 300, the gateway 200 may receive a result obtained by scanning adjacent channels from the terminals 300. The gateway 200 may generate a list by estimating channels having no noise using the scanned result of the adjacent channels.

In addition, the gateway 200 may transmit a control signal that causes the terminals 300 to periodically scan adjacent channels in order to change channels having no interference and noise due to wireless communications (e.g., WLAN or Bluetooth) in a frequency band in which the wireless communications are performed at a preset interval.

According to an exemplary embodiment in the present disclosure, the gateway 200 may set any one of the plurality of channels as a wake up channel and may allocate a plurality of data channels to the wake up channel. Here, the gateway 200 may generate a list including information regarding the plurality of allocated data channels. For example, when the gateway 200 receives a communications request signal from the terminal 300 via the set wake up channel, the gateway 200 may transmit a communications response signal including the list.

In addition, when the gateway 200 receives an activation request signal for registering the data channel from the terminal 300, the gateway 200 may transmit an activation response signal together with an acknowledgement (ACK) signal.

According to an exemplary embodiment, the gateway 200 may include a processing unit, a memory and at least one antenna. Here, the processing unit may include CPU (Central Processing Unit), GPU (Graphic Processing Unit), Microprocessor, ASIC (Application Specific Integrated Circuit) and FPGA (Field Programmable Gate Arrays). And the processing unit may have a plurality of cores. The memory may be a volatile memory, non-volatile memory or a combination thereof.

The terminal 300 may scan the adjacent channel and may transmit the communications request signal via any channel among the scanned channels. For example, when the terminal 300 receives the communications response signal from the gateway 200 via the channel, the terminal 300 may select any one of the plurality of data channels included in the communications response signal and may transmit the activation request signal via the selected data channel.

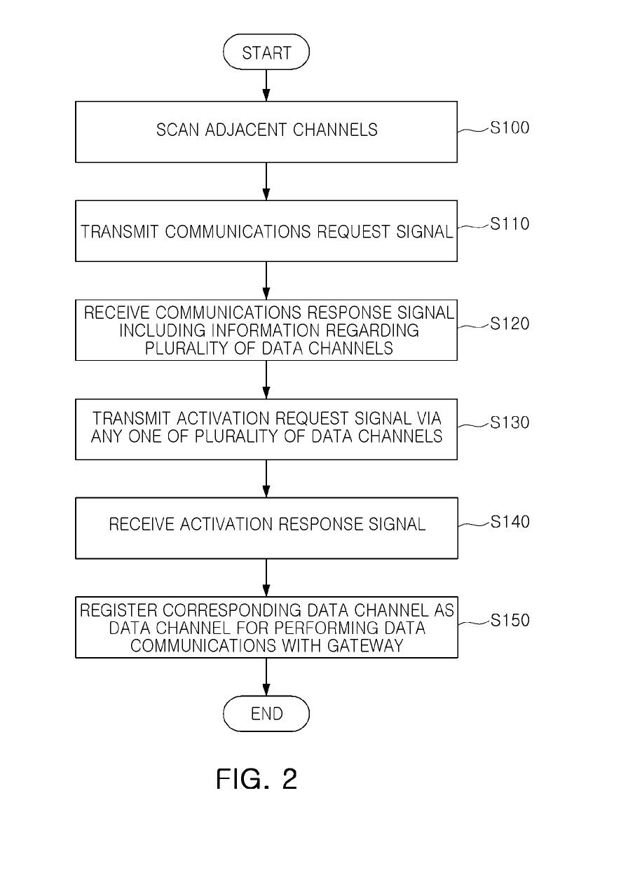

The terminal 300 will be described in more detail below with reference to FIGS. 2 through 5.

FIG. 2 is a flow chart illustrating a wireless communications method according to an exemplary embodiment in the present disclosure.

The wireless communications method according to an exemplary embodiment in the present disclosure may be performed in the wireless communications terminal 300 of FIG. 1.

Referring to FIG. 2, in the wireless communications method according to an exemplary embodiment in the present disclosure, the terminal 300 may first scan adjacent channels (S100).

Next, the terminal 300 may transmit a communications request signal to the gateway 200 via any channel among the scanned channels (S110).

Here, a plurality of channels may be scanned by the terminal 300, and the terminal 300 may transmit the communications request signal while moving through all of the scanned channels according to a predetermined sequence. For example, when the terminal 300 scans a channel 11, a channel 12, and a channel 15, the terminal 300 may transmit the communications request signal while sequentially moving via the channel 11, the channel 12, and the channel 15.

When the gateway 200 receives the communications request signal from the terminal 300 via a preset wake up channel, the gateway 200 may transmit a communications response signal including information regarding the plurality of data channels allocated to the wake up channel.

When the terminal 300 receives the communications response signal (S120), the terminal 300 may transmit an activation request signal to the gateway 200 via any one of the plurality of data channels allocated to the wake up channel (S130).

Next, when the terminal 300 receives an activation response signal corresponding to the activation request signal from the gateway 200 (S140), the terminal 300 may register the corresponding data channel as the data channel (S150) for performing data communications with the gateway.

The terminal 300 in which registration is completed may periodically update data via the registered data channel.

Here, the terminal 300 may be an electronic shelf label (ESL), the wireless communications system may be an electronic shelf label system, and the update information may be product information regarding the electronic shelf label tag.

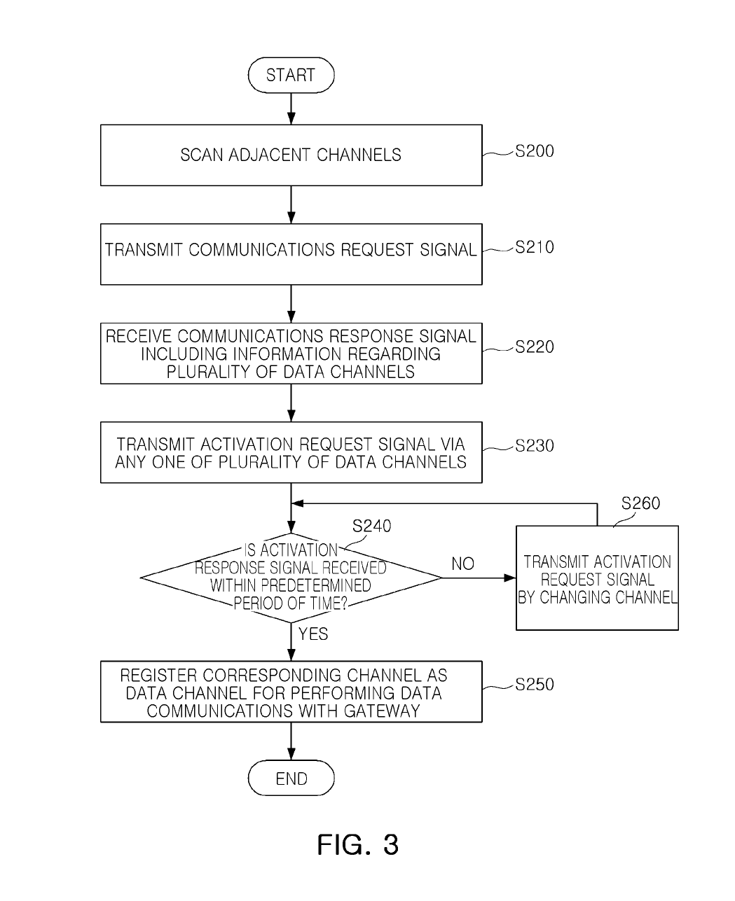

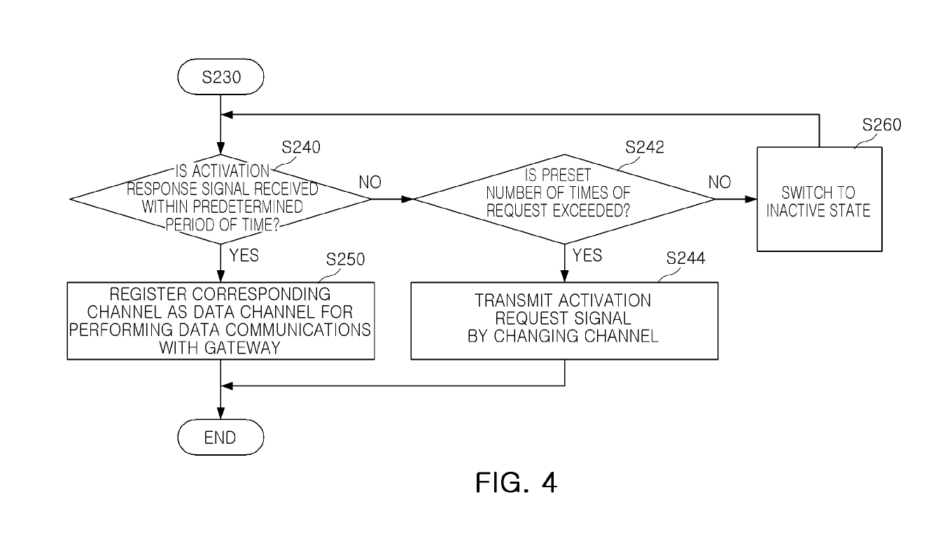

FIG. 3 is a flow chart illustrating a wireless communications method according to another exemplary embodiment in the present disclosure and FIG. 4 is a flow chart illustrating a wireless communications method according to another exemplary embodiment in the present disclosure.

Referring to FIG. 3, the wireless communications method according to another exemplary embodiment in the present disclosure has the same operations as those of FIG. 2 up to the operation (S130) of transmitting the activation request signal to the gateway 200.

In detail, an operation (S200) of scanning adjacent channels, an operation (S210) of transmitting a communications request signal to the gateway 200 via the scanned channel, an operation (S220) of receiving, by the terminal 300, the communications response signal, and an operation (S230) of transmitting an activation request signal to the gateway 200 via any one of a plurality of data channels allocated to a wake up channel are the same as those of FIG. 2.

Next, when the terminal 300 does not receive an activation response signal from the gateway 200 within a predetermined period of time (S240), the terminal 300 may recognize the corresponding data channel as an activation-failed channel and may change the channel to transmit the activation request signal (S260).

Here, the changed channel may be another data channel except for the channel recognized as the activation-failed channel among the plurality of data channels included in the communications response signal received via the wake up channel. According to an exemplary embodiment in the present disclosure, the terminal 300 may change the channel and transmit the activation request signal until the terminal 300 receives the activation response signal.

Next, when the terminal 300 receives an activation response signal corresponding to the activation request signal transmitted via the changed data channel within a predetermined period of time (S240), the terminal 300 may register the corresponding data channel as the data channel (S250) for performing gateway (200) and data communications.

According to an exemplary embodiment in the present disclosure, in the wireless communications method, as illustrated in FIG. 4, when the number of times the channel changes exceeds the preset number of times because the terminal 300 does not receive the activation response signal within the predetermined period of time (S242), the terminal 300 may be switched to an inactive state (S244).

For example, when the preset number of times is four, even in the case that the terminal 300 fails the activation from first channel to a third channel selected from the information regarding the plurality of channels, the terminal 300 transmits the activation request signal by changing the channel. However, when the terminal 300 does not receive the activation response signal for the activation request signal for a fourth channel within the predetermined period of time, the state of the terminal 300 may be switched to the inactive state.

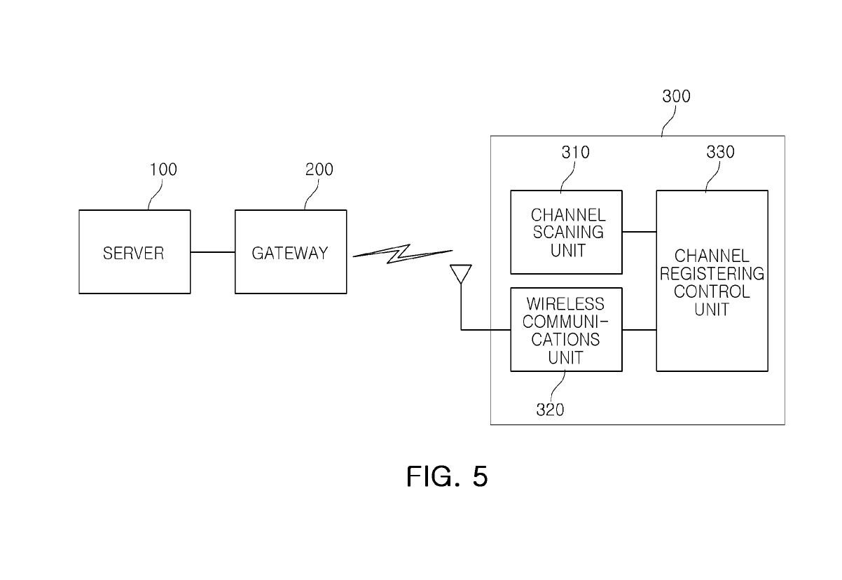

FIG. 5 is a block diagram illustrating a wireless communications terminal according to an exemplary embodiment in the present disclosure.

Referring to FIG. 5, a wireless communications terminal 300 according to an exemplary embodiment in the present disclosure may include a channel scanning unit 310, a wireless communications unit 320, and a channel registering control unit 330.

The channel scanning unit 310 may scan channels around the terminals 300 by scanning adjacent frequency. According to an exemplary embodiment in the present disclosure, the channel scanning unit 310 may scan the channels around the terminal 300 according to scan instructions which are periodically received from the gateway 200.

The wireless communications unit 320 may transmit and receive a wireless signal to and from the gateway 200. The wireless communications unit 320 may transmit information regarding the channels scanned by the channel scanning unit 310 to the gateway 200. In addition, the wireless communications unit 320 may transmit a communications request signal and an activation request signal of the channel registering control unit 330 to the gateway 200, and may receive a communications response signal and an activation response signal of the gateway 200 and transmit the communications response signal and the activation response signal to the channel registering control unit 330.

The channel registering control unit 330 may transmit the communications request signal to the gateway 200 via any channel among the channels scanned by the channel scanning unit 310. In addition, the channel registering control unit 330 may select any one data channel from information regarding a plurality of data channels received from the gateway 200 and may transmit the activation request signal via the selected channel.

In addition, when the channel registering control unit 330 receives the activation response signal from the gateway 200, the channel registering control unit 330 may register the corresponding data channel as the data channel for performing gateway (200) and data communications and may use the registered channel upon performing data communications with the server 100 via the gateway 200 later.

Here, when the channel registering control unit 330 does not receive the activation response signal from the gateway 200 within the predetermined period of time, the channel registering control unit 330 may change the channel and may transmit the activation request signal via the changed channel.

According to an exemplary embodiment in the present disclosure, the channel registering control unit 330 may change the channel by the preset number of times, and when the amount of change times exceeds the preset number of times, the channel registering control unit 330 may be switched to an inactive state.

According to an exemplary embodiment in the present disclosure, when the channel registering control unit 330 transmits the activation request signal for the channel registration with any data channel among the plurality of data channels, the channel registering control unit 330 may set the number of channel registration attempts differently.

For example, when the channel registering control unit 330 receives the communications response signal including information regarding a first channel and a second channel, the channel registering control unit 330 may retransmit the activation request signal to the first channel even in the case that the activation response signal for the first channel is not received within the predetermined period of time, and when the activation response signal for the retransmitted activation request signal is also not received, the channel registering control unit 330 may regard the first channel as the activation-failed channel and perform a channel change to the second channel so as to transmit the activation request signal to the second channel.

According to an exemplary embodiment, the terminal 330 may include a processing unit, a memory and at least one antenna. Here, the processing unit may include CPU (Central Processing Unit), GPU (Graphic Processing Unit), Microprocessor, ASIC (Application Specific Integrated Circuit) and FPGA (Field Programmable Gate Arrays). And the processing unit may have a plurality of cores. The memory may be a volatile memory, non-volatile memory or a combination thereof.

As set forth above, according to exemplary embodiments in the present disclosure, the data communications time may be reduced by registering the data channel for performing data communications with the gateway using a list including information regarding a plurality of data channels, the case in which communications problems such as channel interference, and the like occur, may be rapidly handled by attempting channel registration with another channel when the data channel registration with any channel among the plurality of data channels fails, and battery consumption may be significantly reduced by decreasing the unnecessary registration request attempts.

While exemplary embodiments have been shown and described above, it will be apparent to those skilled in the art that modifications and variations could be made without departing from the scope of the present invention as defined by the appended claims.

What is claimed is:

1. A wireless communications method comprising:
scanning adjacent channels;
transmitting a communications request signal to a gateway via any channel among the scanned channels;
receiving a communications response signal including information regarding a plurality of data channels from the gateway via the channel through which the communications request signal is transmitted;
transmitting an activation request signal to the gateway via any data channel among the plurality of data channels;
receiving an activation response signal from the gateway via the data channel through which the activation request signal is transmitted; and
registering the data channel through which the activation response signal is received as the data channel for performing data communications with the gateway.

2. The wireless communications method of claim 1, further comprising, after the transmitting of the activation request signal, transmitting the activation request signal to the gateway via another data channel among the plurality of data channels when the activation response signal is not received from the gateway within a predetermined period of time.

3. The wireless communications method of claim 2, further comprising, after the transmitting of the activation request signal to the gateway via another data channel among the plurality of data channels, registering the other data channel as the data channel for performing data communications with the gateway when the activation response signal is received from the gateway via the other data channel.

4. The wireless communications method of claim 2, further comprising, after the transmitting of the activation request signal to the gateway via another data channel among the plurality of data channels, transmitting the activation request signal to the gateway by changing the data channel when the activation response signal is not received from the gateway within the predetermined period of time.

5. The wireless communications method of claim 4, wherein the transmitting of the activation request signal by changing the data channel is repeated until the activation response signal is received from the gateway.

6. The wireless communications method of claim 4, wherein the transmitting of the activation request signal by changing the data channel is repeated the preset number of times until the activation response signal is received from the gateway, and switching to an inactive state is performed when the repeated number of transmissions of the activation request signal, repeated by changing the channel, exceeds the preset number of times.

7. A wireless communications terminal comprising:
a channel scanning unit configured to scan adjacent channels;
a wireless communications unit configured to perform wireless communications with a gateway; and
a channel registering control unit configured to transmit a communications request signal to the gateway via the wireless communications unit using any channel among the scanned channels, transmit an activation request signal to the gateway via the wireless communications unit using any one of a plurality of data channels upon receiving a communications response signal including information regarding the plurality of data channels from the gateway, and register the data channel as a data channel for performing the data communications with the gateway upon receiving an activation response signal from the gateway via the data channel.

8. The wireless communications terminal of claim 7, wherein the channel registering control unit transmits the activation request signal by changing the data channel when the channel registering control unit does not receive the activation response signal from the gateway within a predetermined period of time.

9. The wireless communications terminal of claim 8, wherein the channel registering control unit transmits the activation response signal by changing the data channel, by the preset number of times, and is switched to an inactive state when the preset number of times is exceeded.

10. A wireless communications system comprising:
a gateway configured to estimate data channels having no interference using information regarding an adjacent channel and generate a list including information regarding a plurality of data channels being estimated; and
a terminal configured to scan adjacent channels, transmit a communications request signal to the gateway using any channel among the scanned channels, receive a communications response signal including the list from the gateway, transmit an activation request signal to the gateway using any channel among data channels included in the list, and register the data channel as a data channel for performing data communications with the gateway when an activation response signal is received from the gateway via the data channel.

11. The wireless communications system of claim 10, wherein the terminal includes:
a channel scanning unit configured to scan adjacent channels;
a wireless communications unit configured to perform wireless communications with the gateway; and
a channel registering control unit configured to transmit the communications request signal to the gateway via the wireless communications unit using any channel among the scanned channels, transmit the activation request signal to the gateway via the wireless communications unit using any one of a plurality of data channels upon receiving the communications response signal including information regarding the plurality of data channels from the gateway, and set the data channel as the data channel for performing data communications with the gateway upon receiving the activation response signal from the gateway via the data channel.

12. The wireless communications system of claim 11, wherein the channel registering control unit transmits the activation request signal by changing the data channel when the channel registering control unit does not receive the activation response signal from the gateway within a predetermined period of time.

13. The wireless communications system of claim 12, wherein the channel registering control unit transmits the activation response signal by changing the data channel, by the preset number of times, and is switched to an inactive state when the preset number of times is exceeded.
